(19) United States
(12) Patent Application Publication
(10) Pub. No.: US 2018/0337733 A1
(43) Pub. Date: Nov. 22, 2018

(54) OPTICAL MODULE

(71) Applicants: Hisense Broadband Multimedia Technologies Co., Ltd, Qingdao (CN); Hisense Broadband Multimedia Technologies, Ltd., Tortola (VG)

(72) Inventors: Yongzheng TANG, Qingdao (CN); Liangyun DING, Qingdao (CN)

(73) Assignees: Hisense Broadband Multimedia Technologies Co., Ltd, Qingdao (CN); Hisense Broadband Multimedia Technologies, Ltd., Tortola (VG)

(21) Appl. No.: 15/903,975

(22) Filed: Feb. 23, 2018

(30) Foreign Application Priority Data
May 18, 2017 (CN) 201710350608.0
May 18, 2017 (CN) 201710351090.2

(51) Int. Cl. H04B 10/50; G02B 27/10

(52) U.S. Cl. CPC H04B 10/503; G02B 27/1006

(57) ABSTRACT

An optical module for optical communication is provided. According to an example, an optical multiplexer in the optical module or a base for fixing the optical multiplexer is designed to have a protrusion, and the protrusion may be used to control an area of a part applied with adhesive on the bottom of the optical multiplexer. The adhesive is used to bond the optical multiplexer onto the base.

### CROSS REFERENCE TO RELATED APPLICATIONS

This application claims priority to Chinese Patent Application No. 201710351090.2, entitled “Optical Module” and filed on May 18, 2017, and Chinese Patent Application No. 201710350608.0, entitled “Optical Module” and filed on May 18, 2017, both of which are hereby incorporated by reference in their entireties.

### TECHNICAL FIELD

The present disclosure relates to the field of optical communication technology, and particularly, to an optical module.

### BACKGROUND

An optical transceiver module, which is also referred to as an optical module, is a standard module in optical communication devices. A standard optical module may include an optical transmitter, an optical receiver, a microprocessor, a laser driver and the like, where the optical transmitter is configured to convert an electric signal into an optical signal, and may include a laser, an isolator, an optical fiber adapter, and an optical passive component that is configured to couple light emitted from the laser into the optical fiber adapter. Further, in the field of high speed data communications, a plurality of optical signals of different wavelengths may be multiplexed into one optical signal for transmission in a single optical fiber so as to ensure that data may be transmitted at a high speed over a long distance. An optical multiplexer based on Thin Film Filter (TFF) technology may be provided in an optical transmitter to realize multiplexing of optical signals of different wavelengths.

FIG. 1 is a diagram illustrating an optical path of a 40/100 Gbps optical transmitter. As shown in FIG. 1, the optical transmitter may sequentially include four lasers 70 of different wavelengths, four collimating lenses 60, one optical multiplexer 50, one displacement prism 40, one isolator 30, one focusing lens 20 and one adapter 10. The above components may be fixed on a base 80 by an adhesive. FIG. 2 is a schematic diagram illustrating a basic structure of the optical multiplexer 50 in FIG. 1. As shown in FIG. 2, the optical multiplexer 50 may include a rhombic prism 501. Four TFFs may be provided on a sidewall of the rhombic prism 501 close to the collimating lens 60. An antireflection film 503 may be plated on a sidewall of the rhombic prism 501 close to the displacement prism 40 at a position opposite to TFF1, and a high-reflective film 502 may be plated on remaining parts of the sidewall of the rhombic prism 501 close to the displacement prism 40. With the optical multiplexer 50, a laser beam emitted from a first laser 701 may be incident into the rhombic prism 501 via the TFF1 after passing through a first collimating lens 601, and then directly emitted via the antireflection film 503 on the rhombic prism 501. A laser beam emitted from a second laser 702 may be incident into the rhombic prism 501 via TFF2 after passing through the second collimating lens 602, then reflected by the high-reflective film 502 to the TFF1, and finally emitted via the antireflection film 503 on the rhombic prism 501. Similarly, laser beams respectively emitted from a third laser 703 and a fourth laser 704 may be emitted via the antireflection film 503 after being reflected by the high-reflective film 502 twice and three times in the rhombic prism 501, respectively. In this way, four laser beams of different wavelengths may be combined into one laser beam after passing through the optical multiplexer 50. The combined laser beam may pass through the displacement prism 40 to change the transmission path and pass through the isolator 30 before being ultimately coupled into an optical fiber by the focusing lens 20 and the adapter 10.

Since only laser beams with polarization directions consistent with an incidence direction of the isolator 30 are allowed to pass through the isolator 30, it may be necessary that a laser beam entering the isolator 30 has a fixed polarization direction to ensure the isolator 30 may output the laser beam with stable optical power.

### SUMMARY

To overcome the problem in the related art, the present disclosure provides an optical module.

According to a first aspect of the present disclosure, an optical module is provided including a base, a plurality of lasers fixed on the base, an optical multiplexer fixed on the base and configured to combine a plurality of laser beams emitted from the plurality of lasers into one laser beam, and an isolator fixed on the base and configured to receive the laser beam output from the optical multiplexer, where the isolator is positioned in such a way that a light incidence direction of the isolator is consistent with polarization directions of the plurality of laser beams emitted from the plurality of lasers. A bottom surface of the optical multiplexer is provided with a lump-shaped protrusion that is bonded to the base by means of an adhesive, and an area of the lump-shaped protrusion is smaller than an area of a bottom surface of the optical multiplexer.

According to a second aspect of the present disclosure, an optical module is provided including a base, a plurality of lasers fixed on the base, an optical multiplexer fixed on the base and configured to combine a plurality of laser beams emitted from the plurality of lasers into one laser beam, and an isolator fixed on the base and configured to receive the laser beam output from the optical multiplexer, where the isolator is positioned in such a way that a light incidence direction of the isolator is consistent with polarization directions of the plurality of laser beams emitted from the plurality of lasers. The base is provided with a lump-shaped protrusion. A bottom surface of the optical multiplexer is bonded to the lump-shaped protrusion by means of an adhesive, and an area of the lump-shaped protrusion is smaller than an area of a bottom surface of the optical multiplexer.

According to a third aspect of the present disclosure, an optical module is provided including a base, a plurality of lasers fixed on the base, an optical multiplexer fixed on the base and configured to combine a plurality of laser beams emitted from the plurality of lasers into one laser beam, and an isolator fixed on the base and configured to receive the laser beam output from the optical multiplexer, where the isolator is positioned in such a way that a light incidence direction of the isolator is consistent with polarization directions of the plurality laser beams emitted from the plurality of lasers. A bottom surface of the optical multiplexer or the base is provided with an annular protrusion. The bottom surface of the optical multiplexer is bonded to the base by means of an adhesive applied on the annular protrusion.

According to another embodiment of the present disclosure, an optical module is provided including a base, a plurality of lasers disposed on the base, an optical multiplexer disposed on the base and configured to combine a plurality of laser beams emitted from the plurality of lasers into one laser beam, and an isolator disposed on the base and configured to receive the laser beam output from the optical multiplexer. A bottom surface of the optical multiplexer is disposed on the base by means of at least one protrusion and an adhesive.

As can be seen from the above technical solutions, an optical module in the examples of the present disclosure has the following advantages: a bonding area may be effectively controlled when the base and the optical multiplexer are bonded by using an adhesive, thereby controlling the stress resulting from a difference between expansion coefficients of the adhesive and the material of the optical multiplexer and avoiding micro-deformation of the optical multiplexer to output laser beams with stable optical power.

It will be understood that the forgoing general descriptions and the following detailed descriptions are merely illustrative and explanatory, and cannot limit the present disclosure.

### BRIEF DESCRIPTION OF DRAWINGS

The accompanying drawings, which are incorporated in and constitute a part of the present description, illustrate examples consistent with the present disclosure and serve to explain the principles of the present disclosure together with the description.

In order to illustrate more clearly the technical solutions in examples of the present disclosure or the prior art, the accompanying drawings needed to describe the examples or the prior art will be briefly described below. Apparently, other drawings may also be obtained by those of ordinary skill in the art according to these drawings without any creative work.

FIG. 1 is a diagram illustrating an optical path of a typical 40/100 Gbps optical transmitter according to an example of the present disclosure

FIG. 2 is a schematic diagram illustrating a basic structure of the optical multiplexer in FIG. 1 according to an example of the present disclosure.

FIG. 3 is a schematic diagram illustrating a basic structure of an optical multiplexer in an optical module according to an example of the present disclosure.

FIG. 4 is a schematic diagram illustrating a basic structure of an optical multiplexer in an optical module according to another example of the present disclosure.

FIG. 5 is a schematic diagram illustrating basic structures of an optical multiplexer and a base before and after bonding according to an example of the present disclosure.

FIG. 6 is a schematic diagram illustrating attenuations of optical powers of optical beams after passing through an isolator corresponding to protrusions of different areas according to an example of the present disclosure.

FIG. 7 is a schematic diagram illustrating attenuations of optical powers of optical beams after passing through an isolator in a test environment of 25° C. when a protrusion area is 60% that of a bottom surface area of an optical multiplexer according to an example of the present disclosure.

FIG. 8 is a schematic diagram illustrating attenuations of optical powers of optical beams after passing through an isolator in a test environment of 75° C. when a protrusion area is 60% that of a bottom surface area of an optical multiplexer according to an example of the present disclosure.

FIG. 9 is a schematic diagram illustrating a basic structure of an optical multiplexer in an optical module according to an example of the present disclosure.

FIG. 10 is a schematic diagram illustrating a basic structure of an optical multiplexer in an optical module according to another example of the present disclosure.

FIG. 11 is a schematic diagram illustrating a basic structure of a base in an optical module according to an example of the present disclosure.

FIG. 12 is a schematic diagram illustrating a basic structure of a base in an optical module according to another example of the present disclosure.

FIG. 13 is a schematic diagram illustrating a basic structure of an optical multiplexer in an optical module according to further another example of the present disclosure.

FIG. 14 is a schematic diagram illustrating a basic structure of an optical multiplexer in an optical module according to yet another example of the present disclosure.

FIG. 15 is a schematic diagram illustrating a basic structure of an optical multiplexer in an optical module according to still another example of the present disclosure.

FIG. 16 is a schematic diagram illustrating a basic structure of a base in an optical module according to further another example of the present disclosure.

FIG. 17 is a schematic diagram illustrating a basic structure of a base in an optical module according to yet another example of the present disclosure.

FIG. 18 is a schematic diagram illustrating a basic structure of a base in an optical module according to still another example of the present disclosure.

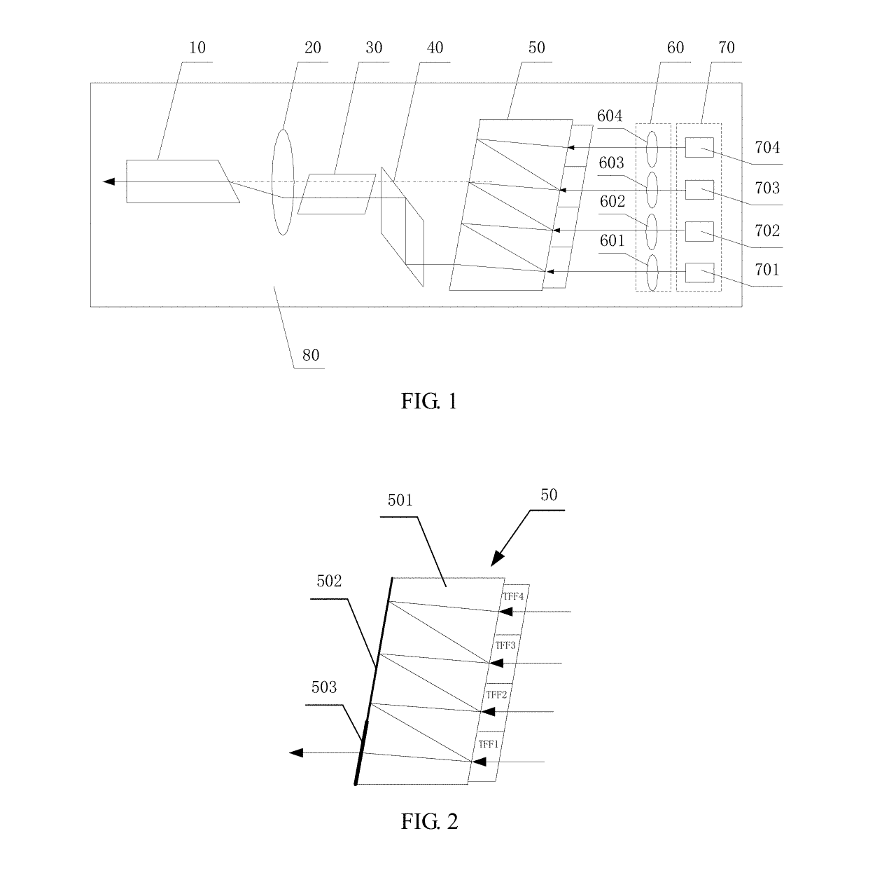

### DETAILED DESCRIPTION

Exemplary embodiments will be described in detail herein with the examples thereof expressed in the drawings. When the following descriptions involve the drawings, like numerals in different drawings represent like elements unless stated otherwise. The implementations described in the following exemplary embodiments do not represent all implementations consistent with the present disclosure. On the contrary, they are merely examples of device and method consistent with some aspects of the present disclosure described in detail in the appended claims.

An isolator is a common optical component in an optical module, which only allows light to pass through itself in one way based on polarization principle of light. The isolator may include two polarizers and a magnet ring. The two polarizers may be positioned at the front and rear sides of the magnet ring. A polarization direction of incident light is consistent with that of a first polarizer, i.e., consistent with an incidence direction of the isolator. Then, after passing through the magnet ring, the incident light may have its polarization plane rotated 45 degrees to be exactly consistent with a light transmission axis direction of a second polarizer (also referred to as a polarization analyser). Hence, all optical signals may pass through the second polarizer. Reflected light induced by an optical path may firstly enter the second polarizer and become linearly polarized light at an angle of 45 degrees with the light transmission axis direction of the first polarizer. After passing through the magnet ring, the linearly polarized light may have its polarization direction further rotated 45 degrees so that the polarization plane may be at an angle of 90 degrees with the light transmission axis of the first polarizer. In this case, the light may not pass through the first polarizer since the polarization direction of the light is orthogonal to the polarization direction of the first polarizer, thereby achieving reverse isolation. Based on the above working principle of the isolator, the polarization direction of the first polarizer in the isolator is referred to as the incidence direction of the isolator in this example.

In a packaging process of an optical module, an optical multiplexer based on the TFF technology may be directly bonded on a base of the optical module by means of an adhesive. During the bonding process, the adhesive may cover an entire bottom region of the optical multiplexer. After the adhesive cures, considerable residual stress may be produced within the optical multiplexer since thermal expansion coefficient of a material of the optical multiplexer differs from those of the above adhesive and a material of the base. The presence of the residual stress may change the polarization direction of an optical beam passing through the optical multiplexer. The optical power of the optical beam passing through an isolator may be changed after the polarization direction of the optical beam is changed. Therefore, a situation of optical power drop may occur after the bonding adhesive cures, and the dropped optical power may even go beyond a range allowed by an optical transmitter.

In addition, after other components are bonded, the optical module may also need to go through baking processes, and each baking may cause the residual stress within the optical multiplexer to change again. Since the polarization direction of an optical beam passing through the optical multiplexer may change along with the change of the residual stress within the optical multiplexer, leading to a continuous change in the optical power of an optical beam passing through the isolator in the packaging process of the optical module. Further, the residual stress within the optical multiplexer may also be different at different temperatures. For example, during a high-low temperature test, the polarization direction of an optical beam may take different changes, resulting in different optical power values output by an optical transmitter at a high temperature and a low temperature.

In view of the above problems, an example of the present disclosure provides a structural design of an optical multiplexer and a base in an optical module. The above structural design follows the basic principle below: controlling the residual stress brought by the cured adhesive to the optical multiplexer by controlling a cover area of the adhesive on the bottom of the optical multiplexer after the optical multiplexer is bonded so as to ensure the stability of the output optical power.

Based on the above principle, the structural design of the optical multiplexer and the base and a method of packaging an optical module in the examples of the present disclosure will be described below in detail in conjunction with the drawings.

An example of the present disclosure provides an optical module. The optical module may include: a base, a plurality of lasers fixed on the base, an optical multiplexer fixed on the base and configured to combine a plurality of laser beams emitted from the plurality of lasers into one laser beam, and an isolator fixed on the base and configured to receive the laser beam output from the optical multiplexer, where the isolator may be positioned in such a way that a light incidence direction of the isolator is consistent with polarization directions of the plurality of laser beams emitted from the plurality of lasers. The optical module may also include other components.

In the above structure, the base in the optical module may be a housing of the optical module, and may also be a substrate, a heat sink or the like disposed on the housing.

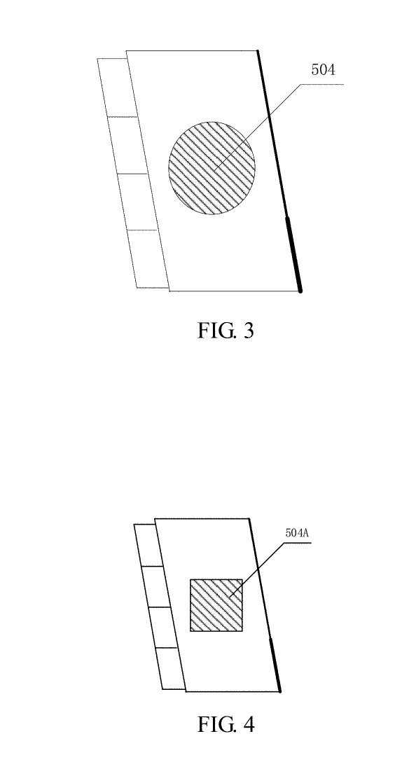

A bottom surface of the optical multiplexer may be provided with a lump-shaped protrusion that may be bonded to the base by means of an adhesive. FIG. 3 is a schematic diagram illustrating a basic structure of an optical multiplexer in an optical module according to an example of the present disclosure.

As shown in FIG. 3, the bottom surface of the optical multiplexer is provided with a circular protrusion 504 protruding from the bottom surface, and an area of the protrusion 504 is smaller than that of the bottom surface of the optical multiplexer.

Based on such factors as material and machining process of the optical multiplexer, the protrusion 504 may be a structure integrated into the optical multiplexer, and may also be a separate structure, which will not be defined herein.

FIG. 4 is a diagram illustrating a structure of an optical multiplexer according to another example of the present disclosure. As shown in FIG. 4, a protrusion 504A on the bottom surface of the optical multiplexer is square. The protrusion may also be designed to be of other shapes such as ellipse, triangle, and irregular shapes, which will not be defined herein.

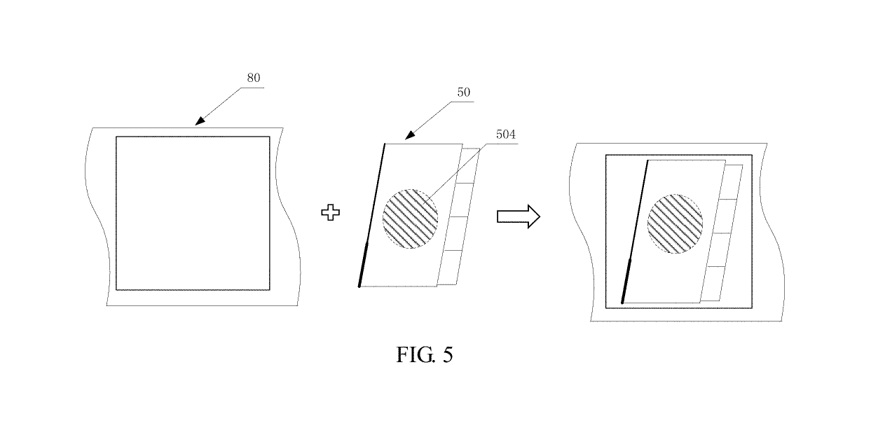

FIG. 5 is a schematic diagram illustrating basic structures of an optical multiplexer and a base before and after bonding according to an example of the present disclosure. As shown in FIG. 5, when the optical multiplexer is bonded, the protrusion 504 may be aligned to the adhesive spread on the base so that the optical multiplexer may be bonded to the base. Alternatively, the protrusion 504 may be coated with an adhesive and then the optical multiplexer may be bonded to a proper position of the base.

After that, the optical multiplexer may be pressed with an appropriate force to flatten the adhesive between the optical multiplexer and the base. In the process of pressing the optical multiplexer, the adhesive may expand on the protrusion 504. If the adhesive does not expand beyond the edge of the protrusion 504, the region of the bottom surface of the optical multiplexer other than the protrusion 504 will not contact the adhesive. If the adhesive is excessive, the excessive adhesive may expand beyond the edge of the protrusion 504 and flow to the periphery of the protrusion 504 because the protrusion 504 protrudes from the bottom surface of the optical multiplexer. In this way, the region of the bottom surface of the optical multiplexer other than the protrusion 504 will not contact the adhesive. Moreover, since the area of the protrusion 504 may be smaller than the area of the bottom surface of the optical multiplexer, the above structure of the protrusion 504 may allow the cover area of the adhesive on the bottom of the optical multiplexer to be effectively controlled and prevent the adhesive from flowing to the light transmission surface of the optical multiplexer.

In the process of bonding the base and the optical multiplexer using the adhesive, the excessive adhesive may flow away from the protrusion or may flow to the periphery of the protrusion. Therefore, the bonding area will not be affected even though excessive adhesive is dispensed, thereby avoiding micro-deformation of the optical multiplexer caused by uneven stress distribution in the case of large-area bonding. Furthermore, the bonding process may be accelerated since there is no need for excessively accurate control on the adhesive dispensing amount.

The cover area of the adhesive on the bottom of the optical multiplexer may be effectively controlled by the protrusion 504. As the characteristic that the residual stress within the optical multiplexer is positively correlated to the cover area of the adhesive on the optical multiplexer, the residual stress within the optical multiplexer may be also well controlled with the controllable cover area of the adhesive on the bottom of the optical multiplexer.

In conclusion, with the above structure of the protrusion 504, the residual stress within the optical multiplexer may become controllable such that a change in a polarization direction of an optical beam passing through the optical multiplexer also becomes controllable. This may effectively prevent a significant variation or attenuation of the output optical power of the optical transmitter and help to increase the stability of the output optical power of the optical transmitter in the optical module.

The height of the protrusion 504 may be designed to be greater than an adhesive thickness considering adhesive may contact the bottom surface of the optical multiplexer when the adhesive used to bond the optical multiplexer is of high viscosity or poor mobility, or when the adhesive dispensed is excessive, where the height of the protrusion 504 refers to a distance between the surface of the protrusion used to contact the base and the bottom surface of the optical multiplexer. The adhesive thickness refers to the thickness of the adhesive spread on the base before bonding the optical multiplexer. With the above design, the excessive adhesive will not contact the bottom surface of the optical multiplexer even though the excessive adhesive expands beyond the edge of the protrusion 504. A difference between the height of the protrusion 504 and the adhesive thickness may be designed according to such influencing factors as type of adhesive and adhesive dispensing amount used in a practical process, for example, the difference may be 20 μm, 50 μm and the like, which will not be specifically limited herein.

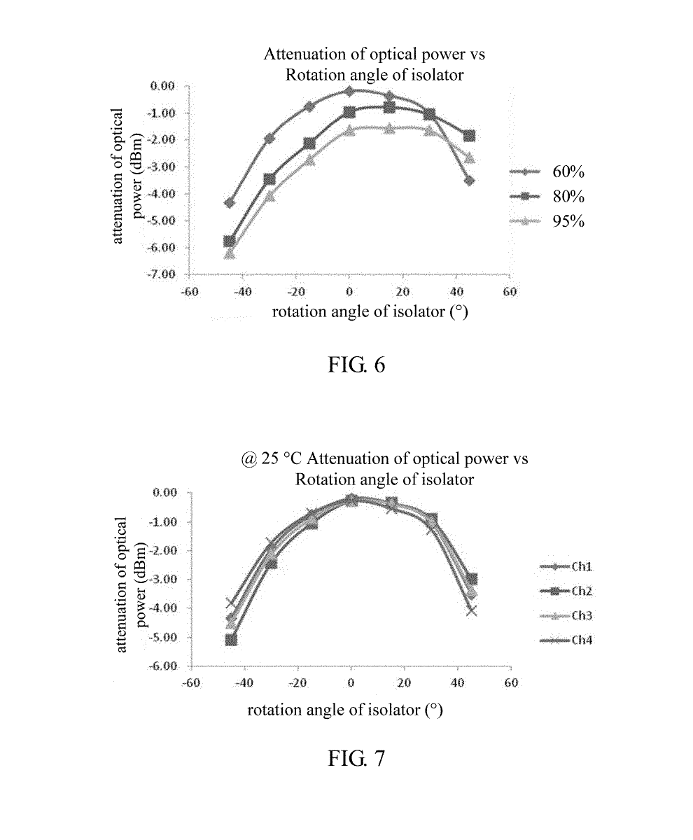

FIG. 6 is a schematic diagram illustrating attenuations of optical powers of optical beams after passing through an isolator corresponding to different protrusion areas according to an example of the present disclosure. In this example, the protrusion 504 may be designed to have different areas, which are 60%, 80% and 95% of the bottom surface area of the optical multiplexer, respectively, and the adhesive for bonding the optical multiplexer is made to cover the whole protrusion. After the adhesive cures, respective attenuation values of the output optical power of a laser beam after passing through isolators having different rotation angles may be tested, where the rotation angle of the isolator corresponding to the maximum optical power of the optical beam after the optical beam passes through the isolator and before the adhesive cures may be set as 0°.

As seen from FIG. 6, in the case of the optical multiplexer of the same model, the adhesive of the same type and the same bonding technology, the smaller the area of the protrusion 504 is, that is, the smaller the cover area of the adhesive on the optical multiplexer is, the smaller the optical power attenuation is after the adhesive cures, and the smaller the change in polarization direction of the optical beam after passing through the optical multiplexer is, that is, the smaller the residual stress within the corresponding optical multiplexer is. Moreover, the polarization direction of the optical beam passing through the optical multiplexer almost takes no change when the area of the protrusion 504 is 60% of the bottom surface area of the optical multiplexer, i.e., when the cover area of the adhesive is 60% of the bottom surface area of the optical multiplexer.

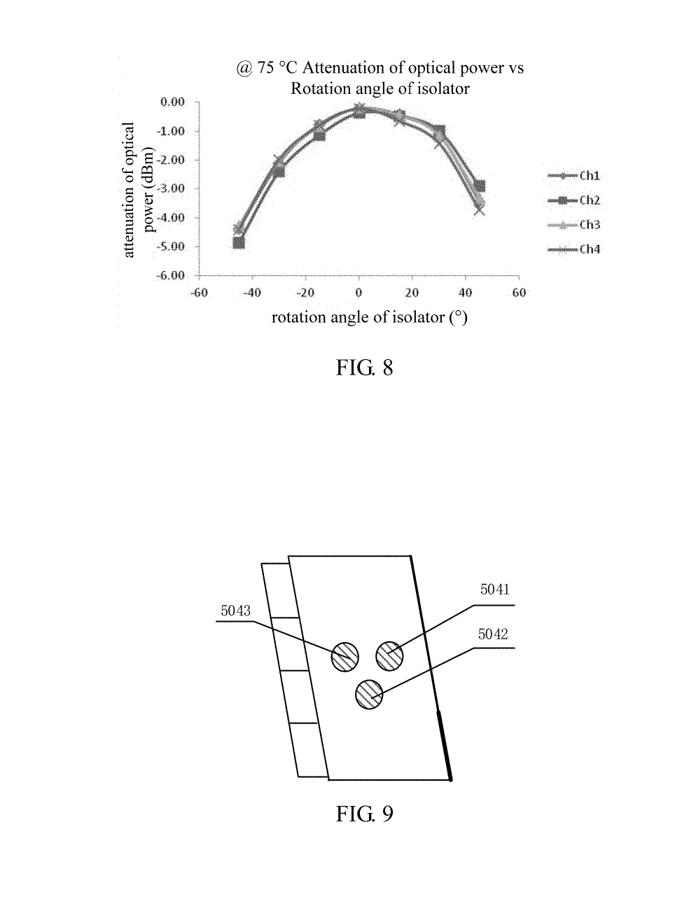

FIG. 7 is a schematic diagram illustrating attenuations of optical powers of optical beams after passing through an isolator in a test environment of 25° C. when a protrusion area is 60% of a bottom surface area of an optical multiplexer according to an example of the present disclosure. FIG. 8 is a schematic diagram illustrating attenuations of optical powers of optical beams after passing through an isolator in a test environment of 75° C. when a protrusion area is 60% of a bottom surface area of an optical multiplexer according to an example of the present disclosure. As seen in FIG. 7 and FIG. 8, when the protrusion area is 60% of the bottom surface area of the optical multiplexer, all the optical beams of four wavelengths passing through the optical multiplexer have no change in polarization direction in the test environments of a high temperature (75° C.) and a low temperature (25° C.), which indicates that the residual stress within the optical multiplexer has no impact on the polarization characteristics of the optical beam under the above conditions. Therefore, the protrusion 504 may be designed to have its area smaller than or equal to 60% of the bottom surface area of the optical multiplexer based on the characteristic that the residual stress within the optical multiplexer is positively correlated to the cover area of the adhesive on the optical multiplexer, thereby effectively solving the optical power falling problem after the bonding and baking of different components of the optical transmitter, and improving communication quality of the optical module.

Moreover, in consideration of bonding strength of the optical multiplexer on the base after the adhesive cures, the area of the protrusion 504 may be designed to be greater than or equal to 20% of the bottom surface area of the optical multiplexer.

If the protrusion is designed to be too small, the corresponding contact area of the optical multiplexer and the base will be small. If the area of a force-bearing point of the optical multiplexer is too small when the optical multiplexer is bonded, it may result in such problems as skewed bonding of optical multiplexer and uneven adhesive on the bottom. In view of the above problems, the bottom surface of the optical multiplexer may be provided with more than two protrusions. For example, the more than two protrusions may be arranged in a dot matrix.

FIG. 9 is a schematic diagram illustrating a basic structure of an optical multiplexer in an optical module according to another example of the present disclosure. As shown in FIG. 9, this example of the present disclosure includes three circular protrusions, which are a first protrusion 5041, a second protrusion 5042 and a third protrusion 5043, respectively. The three protrusions are arranged in a dot matrix, where a total area of the three protrusions may be set to be within a range of 20%-60% of the bottom surface area of the optical multiplexer.

The above three protrusions may be spaced at a particular interval. As the number of the protrusions is increased from one to three or more, the number of the force-bearing points may be increased accordingly and the optical multiplexer may be bonded more flat on the base. Moreover, since more dispersed protrusions on the multiplexer may bring higher stress within the optical multiplexer and cause inconvenience to adhesive dispensing and bonding, the above three protrusions may be set in a central region of the bottom surface of the optical multiplexer.

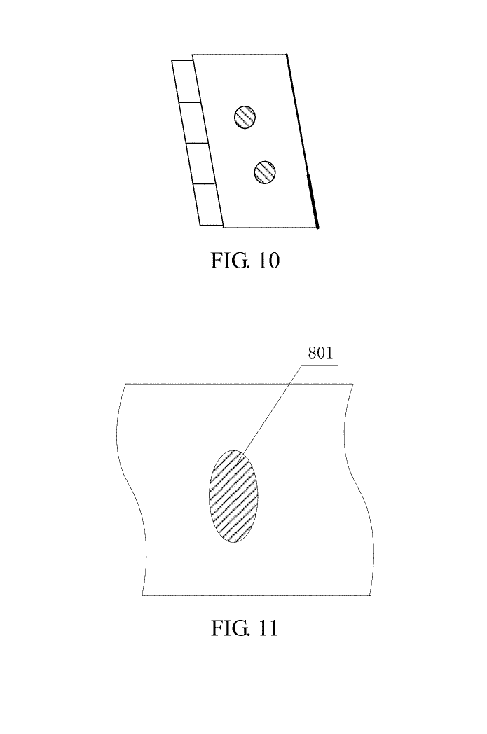

It should be noted that the number of the protrusions is not limited to three provided in this example of the present disclosure, and the number of the protrusions may also be designed according to practical requirements such as the total area of the protrusions and the bottom surface area of the optical multiplexer in a specific application scenario, for example, the number of protrusions may be designed to be two, five, or the like. As shown in FIG. 10, there are two protrusions on the bottom surface of the optical multiplexer.

An example of the present disclosure also provides an optical module that may include a base, a plurality of lasers fixed on the base, an optical multiplexer fixed on the base to combine a plurality of laser beams emitted from the plurality of lasers into one laser beam, and an isolator fixed on the base to receive the laser beam output from the optical multiplexer, where the isolator may be positioned in such a way that a light incidence direction of the isolator is consistent with polarization directions of the plurality of laser beams emitted from the plurality of lasers. The base is provided with a protrusion. A bottom surface of the optical multiplexer may be bonded to the protrusion by means of an adhesive, and the area of the protrusion may be smaller than a bottom surface area of the optical multiplexer. The optical module may also include other components.

Further, the optical multiplexer may be fixed by means of an adhesive spread on the protrusion of the base, and the area of the protrusion may be about 20%-60% of the bottom surface area of the optical multiplexer.

FIG. 11 is a schematic diagram illustrating a basic structure of a base in an optical module according to still another example of the present disclosure. As shown in FIG. 11, a contact region of the base used to bond an optical multiplexing may be provided with a protrusion 801 protruding from the contact region, and the area of the protrusion 801 may be smaller than the area of a bottom surface of the optical multiplexer, where the protrusion 801 may be a structure integrated into the bottom of the base, and may also be a structure welded on the bottom of the base. The shape of the protrusion is also not limited to ellipse provided in the example of the present disclosure, and may also be designed to be other shapes such as circular, square, triangle, and irregular shapes.

When the optical multiplexer is bonded, the above protrusion structure design may allow an appropriate volume of adhesive to be dispensed on the protrusion 801 and then the optical multiplexer may be bonded to the protrusion 801. Then, the optical multiplexer may be pressed with an appropriate force to flatten the adhesive in the contact region of the optical multiplexer and the base. In the process of pressing the optical multiplexer, the adhesive may expand on the protrusion 801, and excessive adhesive may expand beyond an edge of the protrusion 801. Since the protrusion 801 protrudes from the base, the excessive adhesive may flow to the periphery of the protrusion 801 and will not serve for bonding.

Moreover, since the area of the protrusion 801 is smaller than the area of the bottom surface of the optical multiplexer, the cover area of the adhesive may be effectively controlled with the above protrusion 801 structure.

In the process of bonding the base and the optical multiplexer using the adhesive, the excessive adhesive may flow to the periphery of the protrusion. Therefore, the bonding area will not be affected even though excessive adhesive is dispensed, thereby avoiding micro-deformation of the optical multiplexer caused by uneven stress distribution in the case of large-area bonding. Furthermore, the bonding process may be accelerated because there is no need for excessively accurate control on the adhesive dispensing amount.

Further, the height of the protrusion 801 may be designed to be greater than an adhesive thickness since adhesive may contact the bottom surface of the optical multiplexer in case that the adhesive used for bonding the optical multiplexer is of high viscosity and poor mobility or adhesive dispensed on the base is excessive. With the above design, the excessive adhesive will not contact the bottom surface of the optical multiplexer even though the excessive adhesive expands beyond the edge of the protrusion 801. A difference between the height of the protrusion 801 and the adhesive thickness may be designed according to such influencing factors as type of adhesive used and adhesive dispensing amount used in a practical application, for example, the difference may be designed to be 30 μm, 40 μm and the like, which will not be specifically limited herein.

If the protrusion is designed to be small, the corresponding contact area of the optical multiplexer and the base will be small. If the area of a force-bearing point of the optical multiplexer is too small when the optical multiplexer is bonded, it may result in problems of skewed bonding of the optical multiplexer and uneven adhesive on the bottom.

In view of the above problems, the base may be provided with more than two protrusions to increase the number of the force-bearing points so that the optical multiplexer may be bonded more flat on the base. Moreover, since more dispersed protrusions on the multiplexer may bring higher stress within the optical multiplexer and cause inconvenience to the adhesive dispensing and bonding, the above more than two protrusions may be arranged in a dot matrix.

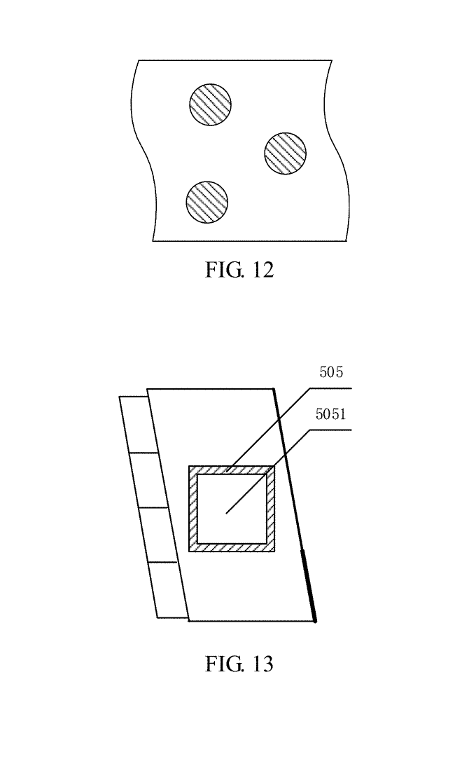

FIG. 12 is a diagram illustrating a base structure including three circular protrusions, and the three circular protrusions are arranged in the dot matrix.

The effect of controlling the bonding area may also be achieved by providing an annular protrusion on the bottom surface of the optical multiplexer. The annular protrusion may define an enclosed region on the bottom surface of the optical multiplexer. By dispensing the adhesive within the enclosed region, the adhesive may be prevented from irregularly flowing around, thereby limiting the bonding area between the bottom surface of the optical multiplexer and the base of the optical module. Further, the adhesive thickness may be even, facilitating even release of the stress.

An example of the present disclosure also provides an optical module that includes a base, a plurality of lasers fixed on the base, an optical multiplexer fixed on the base to combine a plurality of laser beams emitted from the plurality of lasers into one laser beam, and an isolator fixed on the base to receive the laser beam output from the optical multiplexer, where the isolator may be positioned in such a way that a light incidence direction of the isolator is consistent with polarization directions of the plurality of laser beams emitted from the plurality of lasers. The bottom surface of the optical multiplexer may be provided with an annular protrusion, and the bottom surface of the optical multiplexer may be bonded to the base by means of an adhesive dispensed in an enclosed region defined by the annular protrusion.

In the above structure, the base in the optical module may be a housing of the optical module, and may also be a substrate, a heat sink or the like laid on the housing.

FIG. 13 is a schematic diagram illustrating a basic structure of an optical multiplexer in an optical module according to an example of the present disclosure.

Annular protrusion 505 may be a structure integrated into the optical multiplexer, and may also be a separate structure.

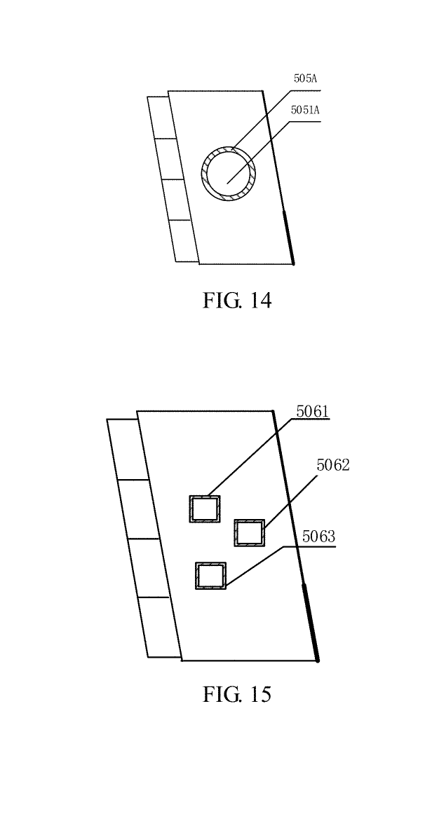

As shown in FIG. 13, the bottom surface of the optical multiplexer is provided with an annular protrusion 505, and a square enclosed region 5051 defined by the annular protrusion 505 is an adhesive dispensing region. It should be noted that the shape of the enclosed region defined by the annular protrusion 505 is not limited to the square provided by an example of the present disclosure. As shown in FIG. 14, the adhesive dispensing region 5051A defined by the annular protrusion 505A is circular. Of course, other shapes such as rectangle, triangle and irregular shapes may also be considered.

To achieve secure bonding between the optical multiplexer and the base while preventing attenuation of optical power, the area of the enclosed region defined by the annular protrusion 505 may be designed to be 20%-60% of the bottom surface area of the optical multiplexer.

Further, there may be more than two annular protrusions on the bottom surface of the optical multiplexer. If a single annular protrusion is provided to bear the weight of the whole optical multiplexer, it may result in such problems as skewed bonding of the optical multiplexer and uneven adhesive on the bottom due to excessively concentrated force to be born. More than two annular protrusions may be provided to equally share the bearing force so that the optical multiplexer may be bonded more flat on the base.

FIG. 15 is a schematic diagram illustrating a basic structure of another optical multiplexer in an optical module according to an example of the present disclosure. As shown in FIG. 15, the bonding area between the optical multiplexer and the base may be obtained by summing up the adhesive dispensing regions defined by annular protrusion 5061, annular protrusion 5062 and annular protrusion 5063, respectively.

Specifically, a plurality of protrusions may be arranged in a dot matrix to achieve balancing of bearing force on the optical multiplexer.

With the above structural design, the bonding area of the adhesive on the optical multiplexer may be controlled by controlling the position distribution and the shape of the annular protrusions, thereby realizing control on the residual stress within the optical multiplexer after the adhesive cures.

Another example of the present disclosure also provides an optical module that includes a base, a plurality of lasers fixed on the base, an optical multiplexer fixed on the base to combine a plurality of laser beams emitted from the plurality of lasers into one laser beam, and an isolator fixed on the base to receive the laser beam output from the optical multiplexer, where the isolator may be positioned in such a way that a light incidence direction of the isolator is consistent with polarization directions of the plurality of laser beams emitted from the plurality of lasers. The base may be provided with an annular protrusion, and a bottom surface of the optical multiplexer may be bonded to the base by means of an adhesive dispensed in the annular protrusion.

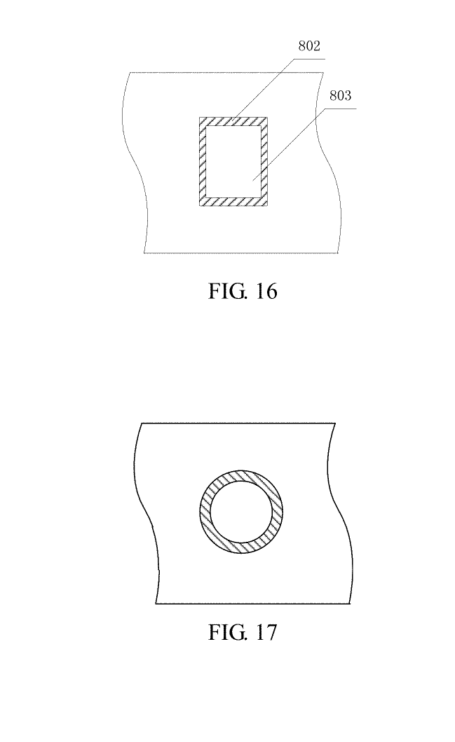

FIG. 16 is a schematic diagram illustrating a basic structure of a base in an optical module according to still another example of the present disclosure. As shown in FIG. 16, an annular protrusion 802 is formed in a contact region used to bond an optical multiplexer on the base, and a region 803 defined by the annular protrusion 802 is an adhesive cover region, where the adhesive may be used to fix the optical multiplexer on the base. It should be noted that the shape of the enclosed region defined by the annular protrusion 802 is not limited to the square provided by the example of the present disclosure, and may also be designed to be other shapes such as circle, rectangle, triangle, and irregular shapes. Also, the number of the annular protrusions 802 is also not limited to the number provided by this example.

FIG. 17 illustrates another structure of a base, where the annular protrusion on the base is circular.

Since the residual stress within the optical multiplexer may decrease with the decrease of bonding area of the adhesive, the enclosed region 803 defined by the annular protrusion 802 on the base may be designed to be 20%-60% of the bottom surface area of the optical multiplexer so as to minimize the influence of the residual stress within the optical multiplexer on the polarization direction of emitted light of the optical multiplexer and allow the optical multiplexer to be sufficiently fixed on the base after the adhesive cures.

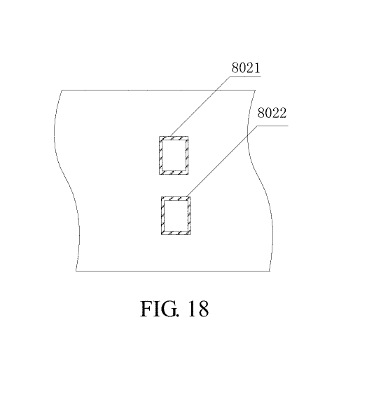

Of course, there may be more than two annular protrusions formed on the base. Further, the more than two annular protrusions may be arranged in a dot matrix on the base. As shown in FIG. 18, by designing the position distribution of an annular protrusion 8021 and an annular protrusion 8022, the area of the regions defined by the two annular protrusions and so on, the adhesive bonding area on the bottom of the optical multiplexer may be controlled, thereby realizing control on the residual stress within the optical multiplexer.

Further, the optical multiplexer is fixed by means of an adhesive covering the bottom surface of the optical multiplexer, and the cover area of the adhesive is 20%-60% of the bottom surface area of the optical multiplexer.

Different examples in the present description are described progressively with mutual reference to the same or similar parts of these examples, and the description of each example places emphasis on its differences from other examples.

After considering the specification and practicing the present disclosure, those skilled in the art may easily conceive of other implementations of the present disclosure. The present disclosure is intended to encompass any variations, uses and adaptive changes of the present disclosure. These variations, uses and adaptive changes follow the general principle of the present disclosure and include common knowledge or conventional technical means in the prior art not disclosed in the present disclosure. The specification and examples herein are intended to be illustrative only and the real scope and spirit of the present disclosure are indicated by the following claims of the present disclosure.

It will be understood that the present disclosure is not limited to the precise structures described above and shown in the accompanying drawings and may be modified or changed without departing from the scope of the present disclosure. The scope of protection of the present disclosure is limited only by the appended claims.

What is claimed is:

1. An optical module, comprising:
a base;
a plurality of lasers disposed on the base;
an optical multiplexer disposed on the base and configured to combine a plurality of laser beams emitted from the plurality of lasers into a laser beam; and
an isolator disposed on the base and configured to receive the laser beam from the optical multiplexer,
wherein a bottom surface of the optical multiplexer is disposed on the base by means of at least one protrusion and an adhesive.

2. The optical module of claim 1, wherein the at least one protrusion is disposed on the bottom surface of the optical multiplexer and bonded to the base by means of the adhesive.

3. The optical module of claim 2, wherein:
a number of the at least one protrusion is more than two, and
each of the at least one protrusion is bonded to the base by means of the adhesive.

4. The optical module of claim 3, wherein, the more than two protrusions are arranged in a dot matrix.

5. The optical module of claim 1, wherein the at least one protrusion is disposed on the base and bonded to the bottom surface of the optical multiplexer by means of the adhesive.

6. The optical module of claim 5, wherein:
a number of the at least one protrusion is more than two, and
each of the at least one protrusion is bonded to the bottom surface of the optical multiplexer by means of the adhesive.

7. The optical module of claim 6, wherein, the more than two protrusions are arranged in a dot matrix.

8. The optical module of claim 1, wherein:
each of the at least one protrusion is a lump-shaped protrusion, and
the adhesive is applied on an end surface of the at least one protrusion.

9. The optical module of claim 8, wherein a sum of area of the end surface of the at least one protrusion is 20%-60% of an area of the bottom surface of the optical multiplexer.

10. The optical module of claim 1, wherein:
each of the at least one protrusion is an annular protrusion, and
the adhesive is accommodated in an enclosed region defined by the at least one protrusion.

11. The optical module of claim 10, wherein a sum of area of the enclosed region defined by each of the at least one protrusion is 20%-60% of an area of the bottom surface of the optical multiplexer.

12. The optical module of claim 1, wherein each of the at least one protrusion has a height greater than a thickness of the adhesive.

13. The optical module of claim 1, wherein the isolator is positioned so that a light incidence direction of the isolator aligns with a polarization direction of the laser beam from the optical multiplexer.
